(19) United States
(12) Patent Application Publication
(10) Pub. No.: US 2008/0122210 A1
(43) Pub. Date: May 29, 2008

(54) Rollover protection system for motor vehicles with an actively deployable rollover body

(75) Inventors: Frank Liesaus, Bergneustadt (DE); Stephan Rohner, Dortmund (DE)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Automotive Group ISE Innomotive Systems Europe GmbH, Bergneustadt (DE)

(21) Appl. No.: 11/986,697

(22) Filed: Nov. 26, 2007

(30) Foreign Application Priority Data
Nov. 24, 2006 (DE) 10 2006 055 491.4

(51) Int. Cl. B60R 21/13

(52) U.S. Cl. 280/756

(57) ABSTRACT

The invention is based on a rollover protection system for motor vehicles that is located behind a last row of seats having a part affixed to the vehicle, and a rollover body that is triggered by a sensor to deploy to a support position from a resting position. To save installation space and still provide the maximum survival area for all passengers of an open passenger vehicle, the invention provides installing a rollover protection system in the middle area behind the last row of seats.

### BACKGROUND OF THE INVENTION

1. Field of the Invention

The invention relates to a rollover protection system for motor vehicles that is located behind a last row of seats and has a part affixed to the vehicle, and a rollover body that is triggered by a sensor to deploy to a support position from a resting position. Such rollover protection systems are for protecting passengers in motor vehicles without a protective roof, typically in convertibles or roadsters, by creating a survival area for the passengers in a rollover.

2. Description of Related Art

It is known to provide a permanently installed roll bar extending the entire width of the motor vehicle (EP 0 233 777 B2), or to assign each vehicle seat a height-adjustable permanently installed roll bar (DE 196 04 423 A1). In addition to this so-called rigid roll bar, widespread constructive solutions for so-called active roll bar systems are available on the market in which the roll bar is normally stored, and a sensor causes it to be quickly set up in a protective, locked position in a dangerous situation such as a pending rollover by means of a energy store to prevent the passengers from being crushed when the motor vehicle rolls over.

These so-called “active” rollover protection systems typically have a U-shaped roll bar for each seat whose bar arms are generally linearly guided within a cassette housing affixed to the vehicle, and the roll bar is normally held by a holding device in a bottom, resting position against the pretension of a drive pressure spring, and the roll bar can be moved into a top, supportive position in a rollover in response to a sensor by means of the spring force when the retention device releases, and a locking device that engages prevents the roll bar from being pressed back into the cassette.

Such a cassette construction of an active rollover protection system is for example shown in DE 100 40 642 C1.

However, rollover protection systems are also known that have a roll bar that can be actively deployed that extend across approximately the entire width of the motor vehicle. The bar head can be designed as a continuous bar shell (DE 195 40 819 C2), or it can have bar-head-like shaped regions in the area of the motor vehicle seat (DE 100 44 930 Cl).

These seat-related cassette constructions as well as the roll bars that extend nearly over the entire width of the motor vehicle have been introduced into the market and are used in many embodiments adapted to the respective type of motor vehicle.

DE 12 10 957 C1 discloses a seat-related rollover protection system with long horn-like extensions that are designed to be flush and mate with the profile of the shank tubes connecting the shaped body. When deployed, the rollover protection systems are “interlocked” as the fronts of the bar heads of neighboring roll bars interlock with each other.

FIG. 7 of DE 39 27 265 C3 shows a vehicle-wide rollover protection system with a two-part roll bar that pivots on a common axis, and the two parts of the rollover protection system are guided in guiding holders fixed to the vehicle while the system is deploying, said holders being directly adjacent to the outside of the vehicle.

The disadvantage of both the seat-related constructions and the roll bars extending nearly the entire width of the vehicle is that they require a substantial amount of space in the rear area between the interior of the vehicle and trunk or roof storage area.

The area between the vehicle interior and trunk or roof storage area is small since the stored roof with its components is directly behind the last row of seats.

Very narrow rollover protection systems are also disclosed that are used in the B column (DE 103 57 398 B3), or are as close as possible to the outside in the vehicle between the back of the rear seats and the partition to the trunk (DD 10 2005 016 371 B3). These rollover protection systems only have a very small rollover protection head in comparison to the entire width of the motor vehicle, and they only protect the passengers when at least two of these systems are used in the vehicle.

DE 10 2004 044 584 A1 discloses a rollover protection system with a support body that is formed by a post-like die which is substantially higher when extended than the highest point of the rest of the vehicle. An equilateral triangle is thereby formed with the A column or the reinforced sidewall parts.

EP 1 344 692 A1 discloses seat-related rollover protection systems whose rollover bodies are formed of tubes, while the connecting piece between the tube legs provides another support surface.

### BRIEF SUMMARY OF THE INVENTION

The invention is based on the problem of locating the above-described rollover protection system such that only a central rollover protection system situated behind the last row of seats of the motor vehicle is required to fully fulfill the protection function for all passengers.

This problem is solved by a rollover protection system for motor vehicles that is arranged behind a last row of seats and has a part fixed to the vehicle, and a rollover body that is triggered by a sensor to deploy from a resting position to a support position, characterized in that the part of the rollover protection system affixed to the vehicle is attached in a middle area behind the last row of seats, wherein a head area of the deployed rollover body covers at least the whole middle area in the transverse direction of the vehicle, and the rollover protection system is arranged so that the rollover body is braced against the motor vehicle body and/or the rollover protection system itself when deployed.

The measure according to the invention of the special arrangement in a vehicle will advantageously save cost since only one rollover protection system is required per vehicle. There is enormous cost pressure in the automobile supplier industry as well among automobile manufacturers themselves that necessitates the search for highly effective and economical protective systems without the disadvantages of the prior solutions.

The placement of the rollover protection system according to the invention advantageously offers more installation space for holding the stored roof, which allows the vehicle to be constructed in a more compact manner.

The last row of seats is designed so that the two outer seats are full seats with corresponding contours, especially for the back. The middle area of the vehicle between the outer seats does not offer a seat or a full seat and accordingly does not have a corresponding contour for the back; instead, padding is generally located in this area.

The full seats have a concave design mostly at least in the back area. Viewed toward the middle of the motor vehicle, there is an approximately tangential transition area toward the middle padding whose contour frequently has a convex curvature. Accordingly the middle area of the vehicle behind the last row of seats offers a “positive delta” area that, viewed in the longitudinal direction of the vehicle, is formed from the difference between the low point of the concave curvature in the back area and the apex of the convex middle padding. This is the area for placing the rollover protection system according to the invention.

Of course, there are also vehicles whose last row of seats are less concave or convex and are designed more or less in a straight line. However, the above-described positive delta is available in both types of motor vehicles for placing a rollover protection system. This positive delta area between the back area and padding is also reflected by the supporting vehicle structure or vehicle body shell.

In the invention, the middle area is understood to be the limited area in the vehicle that, when viewed in the longitudinal direction of the vehicle, is between the mid-lines of at least two seats.

The basic principle of the rollover protection system can have multiple embodiments. For example, a tubular construction is possible for the extendable part of the rollover protection system, i.e., the actual rollover body, is possible as is a cassette system that is formed from profiled sections. Different types of materials can also be used such as steel, plastic (especially fiber-reinforced plastic), magnesium and aluminum. The different materials can also be combined with each other.

The location of the rollover protection system according to the invention has the particular advantage that, in a two-seat vehicle with a lowerable roof, at least the backrest of the passenger seat or the entire passenger seat can be folded down, thereby providing sufficient space for loading. In a four-seat vehicle with a lowerable roof, it is possible for both rear seats or at least the backrests to be folded down to provide two loading areas.

The advantageous development of the invention provides arm-like extensions and support elements that are formed from the rollover body when the rollover body is extended, and provide a secure support on the load-bearing vehicle structure and/or the rollover protection system itself.

The extended survival area is nearly as large as conventional seat-related systems or systems that nearly extend across the entire width of the vehicle.

Described herein is a rollover protection system for motor vehicles for location behind a last row of seats, comprising a part that affixes to a vehicle and a rollover body that is triggered by a sensor to deploy to a support position from a resting position, wherein the part of the rollover protection system that affixes to a vehicle is for location in a middle area behind a last row of seats, and a head area of the rollover body when deployed overlays at least the entire middle area in a transverse direction of a vehicle, and the rollover protection system is designed such that the rollover body is braced against a vehicle body and/or the rollover protection system itself when deployed.

Also included is a vehicle including a rollover protection system, the rollover protection system being located behind a last row of seats in the vehicle and comprising a part affixed to the vehicle and a rollover body that is triggered by a sensor to deploy to a support position from a resting position, wherein the part of the rollover protection system that is affixed to the vehicle is located in a middle area behind the last row of seats of the vehicle, and a head area of the rollover body when deployed overlays at least the entire middle area in a transverse direction of the vehicle, and the rollover protection system is designed such that the rollover body is braced against the a vehicle body of the vehicle and/or the rollover protection system itself when deployed.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. Corresponding embodiments and developments of the invention are cited in the claims and also result from the following description of the figures below.

The invention will be further explained with reference to several advantageous exemplary embodiments portrayed in different views and states in the patent drawings. The drawings show:

FIG. 1 is a plan view of a schematically portrayed section of a convertible with an open roof and symbolically represented retracted rollover protection system in the middle area behind the last row of seats,

FIG. 2 is an isometric view of a schematically portrayed vehicle section with a schematically portrayed deployed rollover protection system,

FIG. 3 is a rear view of a schematically portrayed rollover protection system in FIG. 2 with collapsibly articulated, arm-like extensions and support elements,

FIG. 4 is a rollover protection system according to FIG. 3, but in a position shortly before the arm-like extensions and support elements unfold,

FIG. 5 is a rear view of a second exemplary embodiment of a schematic, deployed rollover protection system, and

FIG. 6 is a rear view of a third exemplary embodiment of a schematic, deployed rollover protection system.

### DETAILED DESCRIPTION OF THE INVENTION

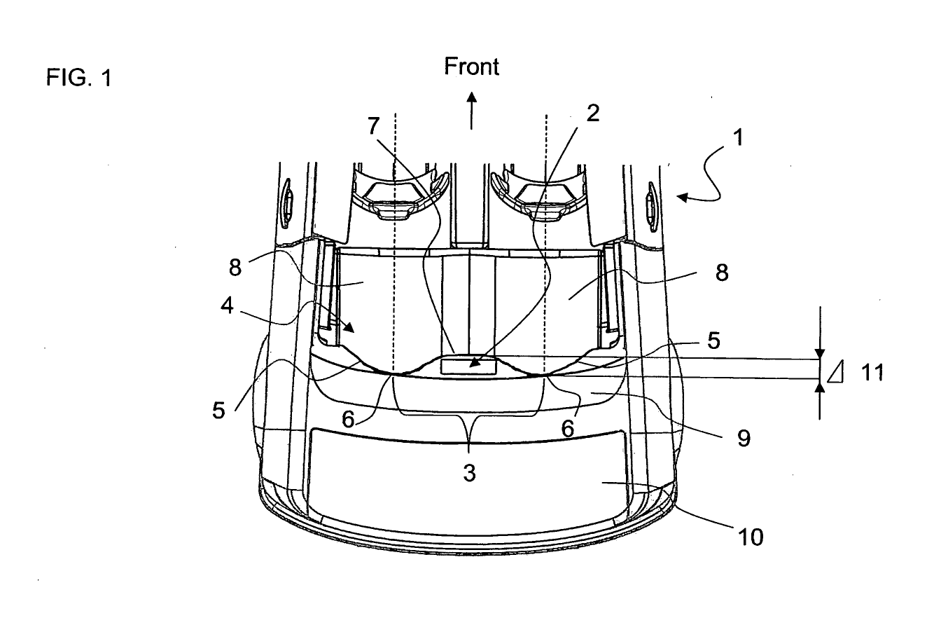

FIG. 1 shows a highly schematic representation of the rear part of a vehicle body 1 with a last row of seats 4 having seat surfaces 8 and a rear seat backrest 5.

According to the invention, a symbolically-indicated active rollover protection system 2 is located in the middle area 3 of the vehicle body 1. The contour of the rear seat backrest 5 is wavy. The rollover protection system 2 is between the apex of a convex contour 7 of the rear seat backrest 5 and the bottom point of a concave contour 6 of the rear seat backrest 5.

A roof cover 9 runs directly behind the rear seat backrest 5. Parts of a stored roof (not shown) are located below a trunk hood 10.

The components necessary for the active rollover protection system 2 to function such as the release unit, the retention device for at the stored roll bar and the locking unit for the deployed roll bar are not shown in the figures, but they are sufficiently known from relevant patents, especially those of the applicant.

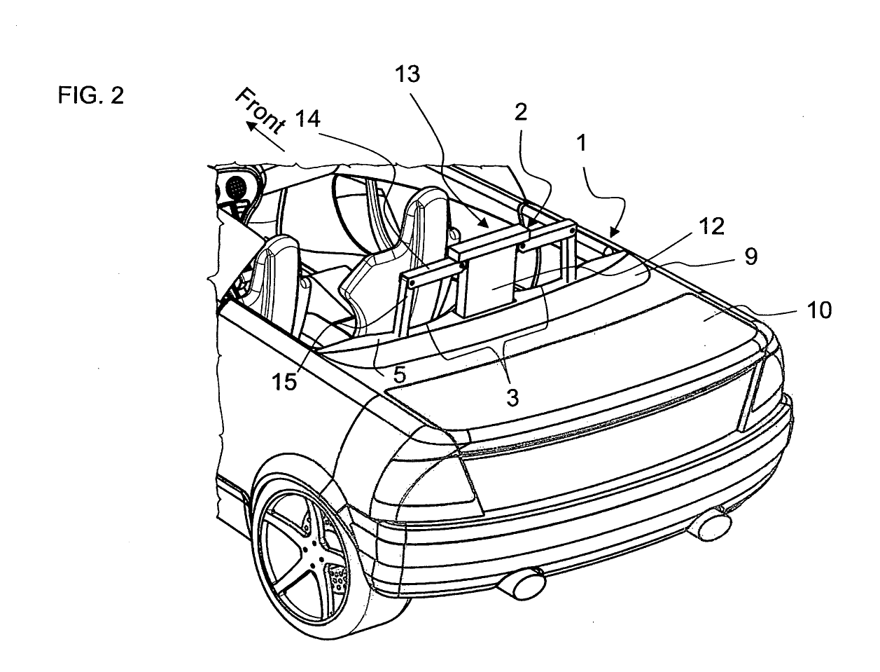

FIG. 2 schematically illustrates the back part of a vehicle body 1 with a deployed rollover protection system 2 having arm-like extensions 14 and support elements 15 that are foldable, spring-loaded and lockable in the deployed position. The parts of the rollover protection system that can be deployed, i.e., the actual rollover body, are essentially formed in this exemplary embodiment by an inner part 12 with a head area 13, the arm-like extensions 14, and the support elements 15.

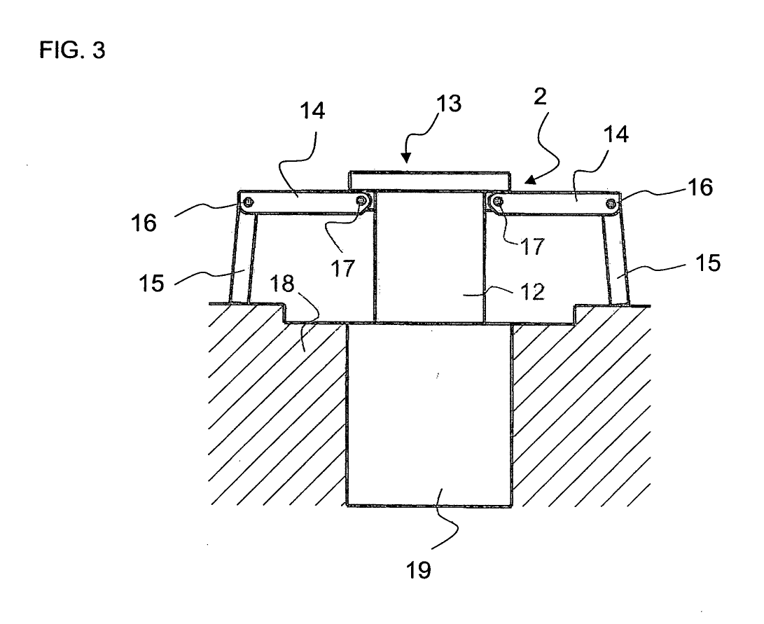

In the head area 13, the arm-like extensions 14 point toward the outside of vehicle. The arm-like extensions 14 are pivoted under spring tension to the inner part 12. The support elements 15 are pivoted to the outside of the extensions 14, said support elements being braced against the vehicle body 1, advantageously in the area of a cover with a supporting vehicle structure 18 underneath (FIG. 3). FIG. 3 shows a rear view of this first variation of the system, and the part 19 of the rollover protection system 2 affixed to the vehicle can also be seen in that it is immovably fastened to the supporting vehicle structure 18. The extended and supporting rollover protection system offers approximately the same amount of survival area as two conventional seat-related systems, or systems that nearly extend the entire width of the vehicle.

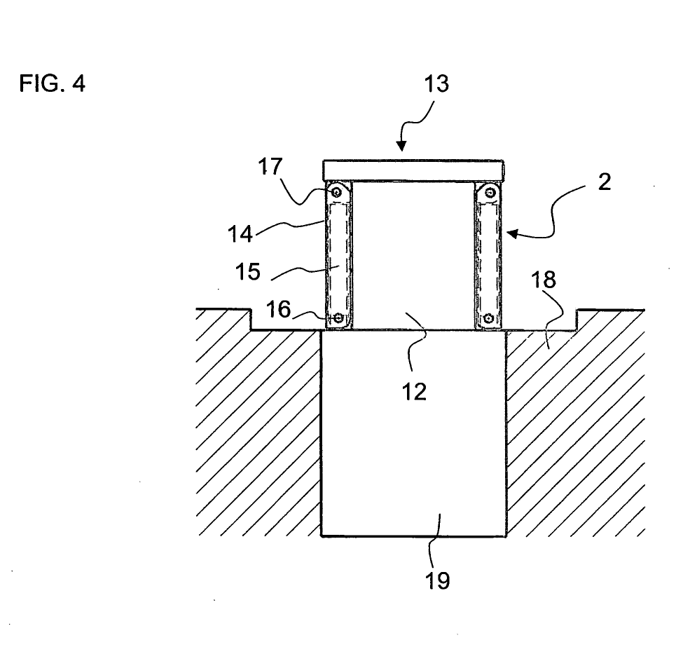

FIG. 4 shows the rollover protection system 2 in the position shortly before the arm-like extensions 14 and the support elements 15 unfold like a jackknife.

After the rollover protection system 2 has received the signal to become deployed, the retention device is released, and the deployable parts of the rollover protection system extend out. The deployment procedure can either be spring actuatable or pyrotechnically initiated. The arm-like extensions 14 at this particular point still contact the narrow sides of the inner part 12 under spring tension. In the exemplary embodiment, the support elements 15 within the arm-like extensions 14 are also under spring tension. Once the roll bar reaches its maximum extension height, the free ends of the extensions 14 are automatically released. They begin to unfold about their pivot points 17. Once they reach their end position, they are locked. In the present exemplary embodiment, the arm-like extensions 14 are approximately orthogonal to the inner part 12 of the rollover protection systems, but any other angle is conceivable. The extensions 14 are swung out on the pivot points on springs that are not shown like the locking units for the extensions 14; however, they are sufficiently known from the prior art. For example, the locking unit can be a latch/bolt lock. During or after the arm-like extensions 14 are unfolded, the support elements 15 are unfolded over the pivot points 16 that, as described above, are spring-loaded in this exemplary embodiment into the U-shaped profile of the extensions 14. The support elements 15 can, like the arm-like extensions 14, be telescopic to ensure a very large survival area for the passengers. Once the support elements 15 are in a support position, they are also locked so that the rollover protection system 2 can be fully effective. In the exemplary embodiment, the support elements 15 are at an angle less than 90° to the supporting vehicle structure 18 viewed from the middle of the vehicle outward, but any other angle is also conceivable.

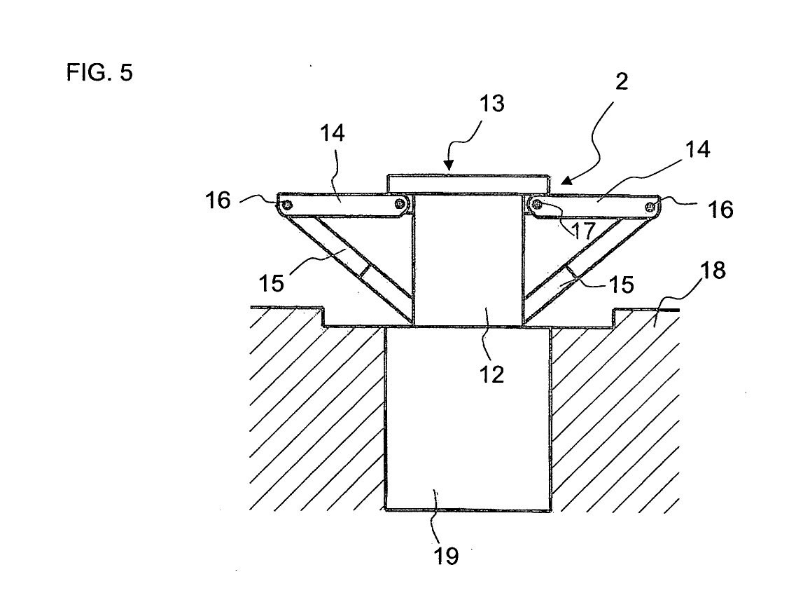

FIG. 5 shows a second exemplary embodiment in which the support elements 15 are braced against the rollover protection system 2. The support elements are kept from unfolding any further by a path limiter acting between a support element 15 and arm-like extension 14.

The support elements 15 can be braced against any location of the inner part, advantageously very close to the part of the rollover protection system 19 affixed to the vehicle, or the part 19 affixed to the vehicle itself.

As is the case with the other exemplary embodiments, the rollover protection system 2 is fastened to the part 19 affixed to the vehicle on the supporting vehicle structure 18.

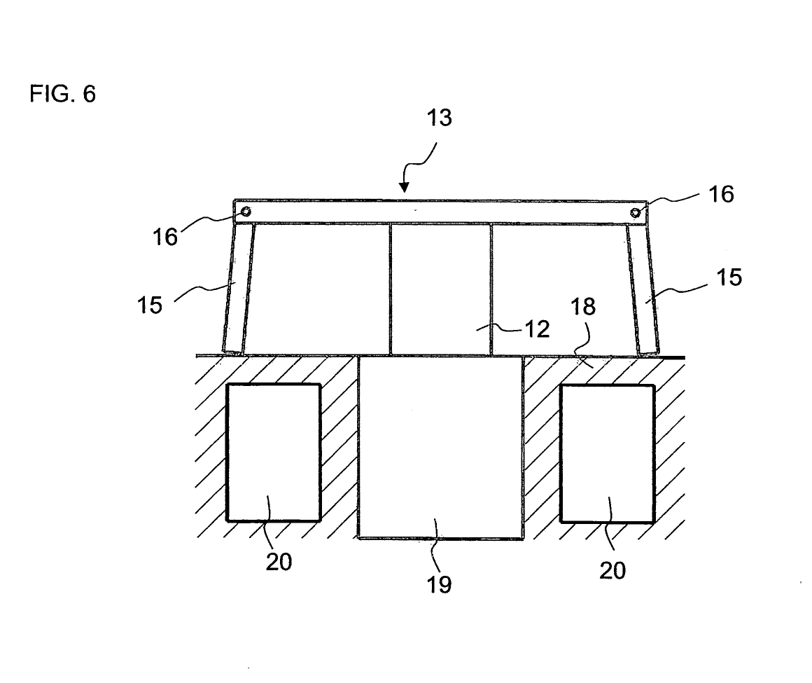

FIG. 6 shows a third exemplary embodiment with arm-like extensions 14 that directly form the head area 13 of the rollover protection system and are not pivoted to the inner part 12. In this exemplary embodiment, only the support elements 15 unfold on the rotary point 16 and are braced against the supporting vehicle structure 18.

The exemplary embodiment shows the especially advantageous incorporation of passages (through loads) 20. This option is also offered in all the other exemplary embodiments.

In another exemplary embodiment (not shown), the arm-like extensions also directly form the head area 13 as in FIG. 6. The support elements 15 are fastened in the outer area of the arm-like extensions 14, and point toward the vehicle floor when the rollover body is extended or retracted. The support elements 15 extend along with the inner part 12, and are braced against the vehicle body 1 when extended.

The advantages of the placement of the rollover protection system 2 according to the invention can be further enhanced by the variable installation location that can be slightly angled with reference to the vehicle cross-section. Depending on the type of vehicle, the supporting vehicle structure is not always perpendicular to the rollover protection system 2 viewed in the direction of the vehicle. A slight offset can arise that, however, can be compensated by slightly angling the installation position of the rollover protection system 2. The support elements 15 would then not lie in the same plane as the arm-like extensions 14 (FIG. 1 to 6) but rather the two planes could be at an offset angle. The points at which force is introduced in a vehicle accident would therefore not lie in a line (FIG. 1 to 6) but would cover a triangle which would advantageously distribute the force. In the exemplary embodiment that is not shown, the triangle is formed by the support elements 15 and the rigid part 19 of the rollover protection system.

### List of Reference Numbers

1 Vehicle body

2 Rollover protection system

3 Middle area

4 Last row of seats

5 Rear seat backrest

6 Concave contour

7 Convex contour

8 Seat surface

9 Roof cover

l0 Trunk hood

11 Delta

12 Inner part

13 Head a rea

14 Arm-like extension

15 Support element

16 Pivot point

17 Pivot point

18 Supporting vehicle structure

19 Part of the rollover protection system affixed to the vehicle

20 Passage

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A rollover protection system for motor vehicles for location behind a last row of seats, comprising a part that affixes to a vehicle and a rollover body that is triggered by a sensor to deploy to a support position from a resting position, wherein the part of the rollover protection system that affixes to a vehicle is for location in a middle area behind a last row of seats, and a head area of the rollover body when deployed overlays at least the entire middle area in a transverse direction of a vehicle, and the rollover protection system is designed such that the rollover body is braced against a vehicle body and/or the rollover protection system itself when deployed.

2. The rollover protection system according to claim 1, wherein the rollover protection system is designed such that the rollover body is braced in an area of a vehicle body having a supporting vehicle structure lying underneath, when the rollover body is deployed.

3. The rollover protection system according to claim 2, wherein the head area of the rollover body has arm-like extensions that extend beyond the middle area toward the outside of a vehicle when they are deployed.

4. The rollover protection system according to claim 3, wherein support elements work in combination with the arm-like extensions, the support elements being braced against a vehicle body and/or the part of the rollover protection system that affixes to a vehicle.

5. The rollover protection system according to claim 3, wherein the arm-like extensions are articulated to the rollover body such that they are formed out of the rollover body when the rollover body is deployed.

6. The rollover protection system according to claim 3, wherein the arm-like extensions are rotatably mounted and spring-loaded.

7. The rollover protection system according to claim 4, wherein the support elements are articulated to the arm-like extensions such that they are formed out of the rollover body when the rollover body is deployed.

8. The rollover protection system according to claim 4, wherein the support elements are rotatably mounted and spring-loaded.

9. The rollover protection system according to claim 4, wherein the arm-like extensions and/or the support elements are lockable in a deployed position.

10. The rollover protection system according to claim 4, wherein the arm-like extensions and/or in the support elements are telescopic.

11. The rollover protection system according to claim 1, wherein the rollover protection system is designed such that at least one part of seats next to the part of the rollover protection system that affixes to a vehicle can be unfolded outward to form at least one passage.

12. The rollover protection system according to claim 1, wherein the rollover protection system when deployed is designed such that force introduction points of elements braced against a vehicle body do not lie in a line but rather form a triangle.

13. The rollover protection system according to claim 4, wherein the support elements are fastened in an outside area of the fixed arm-like extensions and face toward a floor of a vehicle.

14. The rollover protection system according to claim 1, wherein an installation position of the rollover protection system is angled in relation to a vehicle cross-section.

15. A vehicle with a rollover protection system according to claim 1.
